(19) United States
(12) Patent Application Publication
(10) Pub. No.: US 2026/0362560 A1
(43) Pub. Date: Nov. 12, 2026

(54) Microwave Oven Door and Corresponding Hinge System

(71) Applicant: WHIRLPOOL CORPORATION, Benton Harbor, MI (US)

(72) Inventors: Xiaojun GUO, Shenzhen (CN); Ryan LI, Shenzhen (CN); Roger WANG, Shenzhen (CN); Winner WANG, Shenzhen (CN); Weihua ZHAO, Shenzhen (CN)

(21) Appl. No.: 19/205,482

(22) Filed: May 12, 2025

(51) Int. Cl. H05B 6/64; E05D 7/10

(52) U.S. Cl. CPC H05B 6/6414; E05D 7/1061

(57) ABSTRACT

A hinge assembly includes a pivot pin, a locking plate, and a lock pin. The pivot pin is secured to a microwave housing. The locking plate is pivotably secured to the microwave door. The locking plate is operable to rotate to a locked position to lock the pivot pin such that the pivot pin facilitates rotation of the microwave door about the pivot pin to transition the microwave door between opened and closed positions. The locking plate is also operable to rotate to an unlocked position to unlock the pivot pin such that the microwave door is detachable from the microwave housing at the pivot pin. The lock pin is operable to engage the locking plate to maintain the locking plate in the locked position. The lock pin is also operable to disengage the locking plate to facilitate transitioning the locking plate to the unlocked position.

### TECHNICAL FIELD

The present disclosure relates to an appliance that is configured to cook food, such as an oven or a microwave oven.

### BACKGROUND

Microwave ovens may include doors that are operable to provide access to a designated cooking space.

### SUMMARY

A microwave oven includes a housing, a door, a hinge assembly, and a locking pin. The housing defines an internal cavity configured to receive foodstuffs for cooking therein. The door is operable to transition between opened and closed positions to provide and restrict access to the internal cavity, respectively. The hinge assembly is operable to rotatably secure to the door to the housing and to release the door from the housing. The hinge assembly includes a pivot pin, a hinge plate, and a locking plate. The pivot pin is attached to the housing. The hinge plate is secured to the door and defines a slot. The slot is operable to receive the pivot pin such that the door is rotatable between the opened and closed positions via the engagement between the pivot pin and the hinge plate within the slot. The slot is also operable to release the pivot pin from the slot to facilitate releasing the door from the housing. The locking plate is operable to transition to a locked position to maintain the pivot pin within the slot. The locking plate is also operable to transition to an unlocked position to eject the pivot pin from the slot. The locking pin is operable to engage the locking plate to facilitate maintaining the locking plate in the locked position. The locking pin is also operable to disengage the locking plate to facilitate transitioning the locking plate to the unlocked position.

A hinge assembly includes a striker pin, a fork bolt, and a lock pin. The striker pin is secured to one of a microwave door and a microwave housing. The fork bolt is pivotably secured to the other of the microwave door and the microwave housing. The fork bolt is operable to rotate to a first position to lock the striker pin such that the striker pin facilitates rotation of the microwave door about the striker pin relative to the microwave housing to transition the microwave door between opened and closed positions. The fork bolt is also operable to rotate to a second position to unlock the striker pin such that the microwave door is detachable from the microwave housing at the striker pin. The lock pin is operable to advance to engage the fork bolt to maintain the fork bolt in the first position. The lock pin is also operable to retract to disengage the fork bolt to facilitate transitioning the fork bolt to the second position.

A microwave oven includes a cabinet, a door, a hinge assembly, and a resilient clip. The door is operable to transition between opened and closed positions. The hinge assembly includes a pin and a hinge bracket. The pin is secured to one of the cabinet and the door. The hinge bracket is secured to the other of the cabinet and the door. The resilient clip is secured to the hinge bracket. The resilient clip is operable to receive the pin in response to a first force from the pin acting on the resilient clip in a first direction. The resilient clip is also operable to facilitate rotational movement between the pin and the hinge bracket to transition the door between the opened and closed positions. The resilient clip is also operable to release the pin to detach the door from the cabinet at the pin in response to a second force from the pin acting on the resilient clip in a second direction.

### BRIEF DESCRIPTION OF THE DRAWINGS

FIG. 1 is an isometric front view of a microwave oven having a door with the door in a first opened position;

FIG. 2 is an isometric front view of the microwave oven with the door in a second opened position;

FIG. 3 is a partial isometric cut-away top view of the microwave oven illustrating a first configuration of a door hinge assembly with the door hinge assembly in a detached condition;

FIG. 4 is a partial isometric cut-away top view of the microwave oven illustrating the first configuration of the door hinge assembly with the door hinge assembly in an attached condition;

FIG. 5 is partial cut-away internal view of the door illustrating a second configuration of the door hinge assembly;

FIG. 6 is a partial isometric cut-away exploded top view of the microwave oven illustrating the second configuration of the door hinge assembly with the door hinge assembly in a detached condition;

FIG. 7 is a partial isometric cut-away top view of the microwave oven illustrating the second configuration of the door hinge assembly with the door hinge assembly in an attached condition;

FIG. 8 is a bottom isometric view of a locking plate of the second configuration of the door hinge assembly with the locking plate in a locked position; and

FIG. 9 is a bottom isometric view of the locking plate with the locking plate in an unlocked position.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

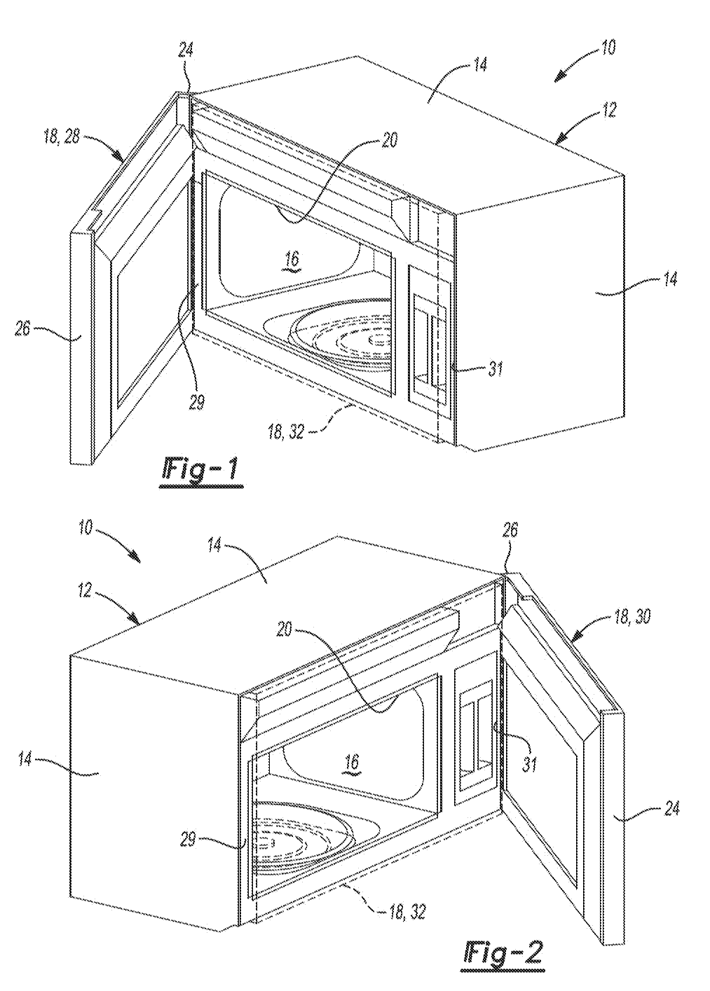

Referring to FIGS. 1 and 2, front isometric views of a microwave oven 10 are illustrated. FIGS. 1 and 2 may more specifically be right and left front isometric views of the microwave oven 10, respectively, or vice versa. The microwave oven 10 includes a cabinet or housing 12. The housing 12 includes a plurality of panels or walls 14 that define an internal cavity 16 in which food or foodstuffs may be placed or received for cooking. Stated in other terms the internal cavity 16 may be configured to receive food or foodstuffs. The plurality of walls 14 may include a top wall, a bottom wall, and three side walls. The housing 12 may further define an opening 20 configured to provide access to the internal cavity 16. The microwave oven 10 also includes a door 18. The door 18 may be rotatably attached or secured to the to the housing 12. For example, the door 18 may be rotatably secured or attached to the housing 12 via hinges or hinge assemblies along a first end region or first side 24 and/or along a second end region or second side 26 of the door 18. Here, hinge assemblies, or specific elements of the hinge assemblies, may be attached to and detachable or releasable from each of the first side 24 and second side 26 of the door 18 so that the door 18 may pivot to a first open position 28 along the first side 24 of the door and a first side or end region 29 of the housing 12 (e.g., FIG. 1), and to a second open position 30 along the second side 26 of the door 18 and a second side or end region 31 of the housing 12 (e.g., FIG. 2). The door 18 provides access to the opening 20 and internal cavity 16 when in either open position (e.g., the first open position 28 or the second open position 30). The door 18 covers the opening 20 and the internal cavity 16 when in the closed position 32.

The microwave oven 10 may include a microwave generating device, such as a magnetron or a solid-state device. The microwave oven 10 may include a waveguide that defines a pathway or channel on an opposing side of a wall of the plurality of walls 14 relative to the internal cavity 16. The wall of the plurality of walls 14 may define an orifice that establishes communication between the internal cavity 16 and the pathway or channel. A waveguide cover may be disposed over the orifice within the internal cavity 16. The pathway or channel of the waveguide is configured to direct microwaves from the microwave generating device, through the waveguide cover, and to the internal cavity 16 in order to cook any food that is disposed within the internal cavity 16.

The microwave oven 10 may also include a power supply, such as a transformer, that provides electrical power to the microwave generating device, a capacitor, and a cooling fan. The cooling fan may be configured to cool the various components of the microwave oven 10, such as the microwave generating device, power supply, capacitor, etc.

The electronic components (e.g., microwave generating device, fan motors, power supply, capacitors, etc.) of the microwave oven 10 may be connected to a control panel, such as a human machine interface (HMI), and a controller, so that an operator may control various parameters. For example, the operator may be configured to input a cooking time, a cooking temperature, a desired mode of cooking (e.g., microwave cooking, defrost, etc.).

The controller may be part of a larger control system and may be controlled by various other controllers throughout the microwave oven 10. It should therefore be understood that the controller and one or more other controllers can collectively be referred to as a “controller” that controls various functions or components of the microwave oven 10 in response to signals from various sensors to control the various functions or components of the microwave oven 10. The controller may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller in controlling the microwave oven 10.

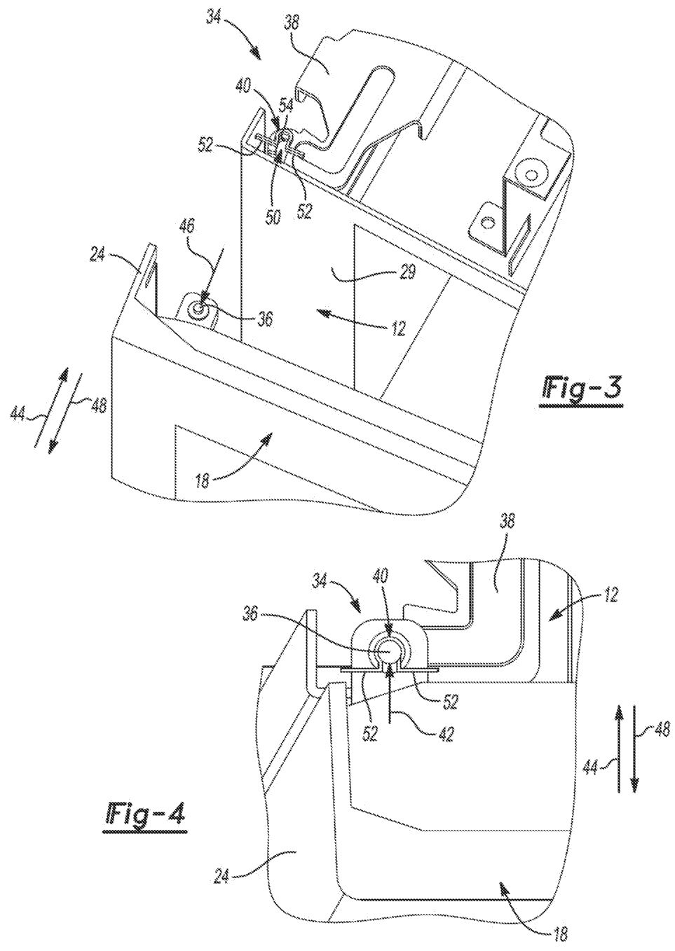

Referring to FIG. 3 and 4, a first configuration of a door hinge assembly 34 is illustrated. It is noted that the views in FIGS. 3 and 4 may include cutaway sections or regions where external panels or other elements of the microwave 10 have been removed so that the elements of door hinge assembly 34 are visible. The hinge assembly 34 is operable to rotatably secure to the door 18 to the housing and to eject or release the door 18 from the housing 12 along one side of the door (e.g., the first side 24 or the second side 26 of the door 18). The microwave 10 may include multiple hinge assemblies 34 (e.g., two or more hinge assemblies) that may be attached to and detachable or releasable from opposing sides of the door 18 (e.g., the first side 24 or the second side 26 of the door 18) and/or the opposing side or end regions of the housing 12 (e.g., the first side or end region 29 and the second side or end region 31) so that the door 18 may open to either the first open position 28 or the second open position 30 as illustrated in FIGS. 1 and 2. Furthermore, each of the opposing sides of the door 18 (e.g., the first side 24 and the second side 26) and/or the opposing side or end regions of the housing 12 (e.g., the first side or end region 29 and the second side or end region 31) may include at least two hinge assemblies (e.g., an upper and a lower hinge assembly 34). More specifically, some elements of the hinge assemblies 34 may be attached to the door 18, while other elements of the hinge assemblies 34 may be attached to the housing 12, and the disengagement between the elements of the hinge assemblies 34 that are attached to the door 18 from the elements of the hinge assemblies 34 that are attached to the housing 12 will result in detachment or release of the door 18 from the housing 12 along the correspond side of the door 18 and the correspond side or end region of the housing 12.

It is noted that the hinge assembly 34 illustrated in FIGS. 3 and 4 is positioned along the first side 24 of the door 18 and the first side or end region 29 of the housing 12. The hinge assembly 34 depicted in FIGS. 3 and 4, however, may be representative a hinge assembly 34 that is positioned along the second side 26 of the door 18 and the second side or end region 31 of the housing 12. It should be understood, therefore, that a hinge assembly 34 that is positioned along the second side 26 of the door 18 and the second side or end region 31 of the housing 12 may be a mirror image of what is illustrated in FIGS. 3 and 4.

The hinge assembly 34 includes a pivot, pivot pin, or pin 36 secured to the door 18, a hinge bracket 38 secured to the housing 12, and a snap or resilient clip 40 secured to the hinge bracket 38. It is noted that the configuration could be reversed (e.g., the pin 36 could be secured to the housing 12 while the hinge bracket 38 is secured to the door 18). The resilient clip 40 is operable to receive the pin 36 in response to a first force 42 from the pin 36 acting on the resilient clip 40 in a first direction 44 (e.g., FIG. 4). The first force 42 may be transferred to the pin 36 via an operator that is closing and pushing on the door 18. The resilient clip 40 is operable to facilitate rotational movement between the pin 36 and the hinge bracket 38 to transition the door 18 between an opened position (e.g., the first open position 28 or the second open position 30) and a closed position (e.g., the closed position 32). The resilient clip 40 is also operable to release the pin 36 to detach or release the door 18 from the cabinet or housing 12 at the pin 36 in response to a second force 46 from the pin 36 acting on the resilient clip 40 in a second direction 48 (e.g., FIG. 3). The second force 46 may be transferred to the pin 36 via an operator that is opening and pulling on the door 18 on the respective side of the door 18 (e.g., the first side 24 or the second side 26) associated with the particular hinge assembly 34.

The first force 42 and the second force 46 may each comprise lateral forces relative to an axis of rotation of pin 36. For example, the first force 42 and the second force 46 may each be substantially perpendicular to an axis about which the pin 36 rotates within the resilient clip 40. As used herein, substantially perpendicular refers to any incremental angle that is between exactly perpendicular and 15° or less from exactly perpendicular (e.g., 12.5° or less from exactly perpendicular, 10° or less from exactly perpendicular, 5° or less from exactly perpendicular, 1° or less from exactly perpendicular, 0.5° or less from exactly perpendicular, 0.1° or less from exactly perpendicular, etc.).

A first of the hinge assemblies 34 may be disposed along the first side 24 of the door 18. A second of the hinge assemblies 34 may be disposed along the second side 26 of the door 18. The first of the hinge assemblies 34 may facilitate rotating the door 18 relative to the housing 12 along the first side 24 of the door 18 in response to the resilient clip 40 of the first of the hinge assemblies 34 receiving the pin 36 of the first of the hinge assemblies 34, and the resilient clip 40 of the second of the hinge assemblies 34 releasing the pin 36 of the second of the hinge assemblies 34. The second of the hinge assemblies 34 may facilitate rotating the door 18 relative to the housing 12 along the second side 26 of the door 18 in response to the resilient clip 40 of the second of the hinge assemblies 34 receiving the pin 36 of the second of the hinge assemblies 34, and the resilient clip 40 of the first of the hinge assemblies 34 releasing the pin 36 of the first of the hinge assemblies 34.

The resilient clip 40 defines an open end 50. The open end 50 is operable for guiding the pin 36 into and out of the resilient clip 40. The resilient clip 40 includes first and second resilient arms 52 disposed on opposing sides of the open end 50. The first and second resilient arms 52 may extend outward in opposing or opposite directions. The resilient clip 40 may therefore have an omega shape. The resilient clip 40 may be made from a flexible or resilient material (e.g., spring steel, flexible plastic, etc.) such that the open end 50 of the resilient clip 40 widens to receive or release the pin 36 within a central opening 54 defined by the resilient clip 40 in response to the pin 36 applying the first force 42 or the second force 46 to the resilient clip 40. Once the pin 36 is disposed within the central opening 54, the open end 50 of the resilient clip 40 narrows trapping the pin 36 within the central opening 54. The first and second resilient arms 52 may also expend outward and retract inward in response to the open end 50 widening and narrowing, respectively.

The resilient clip 40 is operable to receive and release the pin 36 in response to the first force 42 and the second force 46 exceeding first and second thresholds, respectively. However, if the first force 42 is less than the first threshold, the open end 50 of the resilient clip 40 will not sufficiently widen to receive the pin 36 and if the second force 46 is less than the second threshold, the open end 50 of the resilient clip 40 will not sufficiently widen to release or eject the pin 36. The resilient clip 40 facilitates rotational movement of the pin 36 within the resilient clip 40, and hence rotation of the door 18 relative to the housing 12, when the pin 36 is disposed within the resilient clip 40 and the second force 46 is less than the second threshold. For example, the resilient clip 40 engages the pin 36 is the same manner as bearing, a bushing, etc. engages a shaft that is rotatable therein.

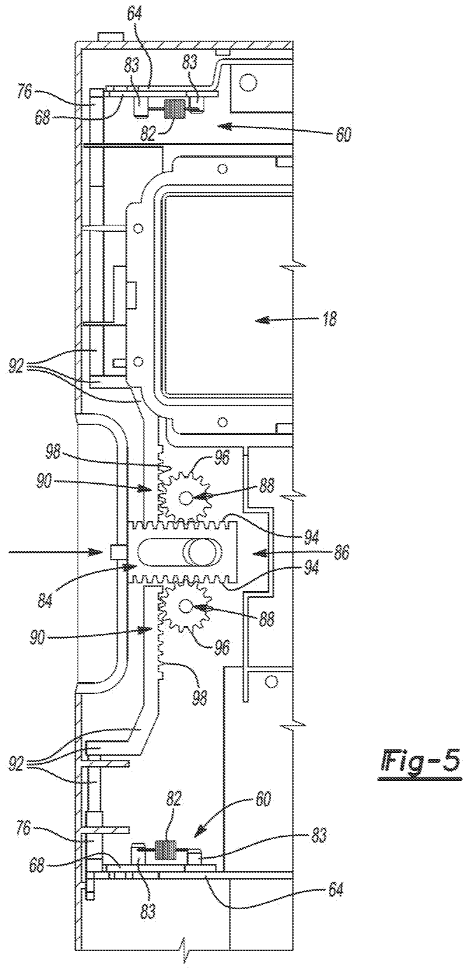

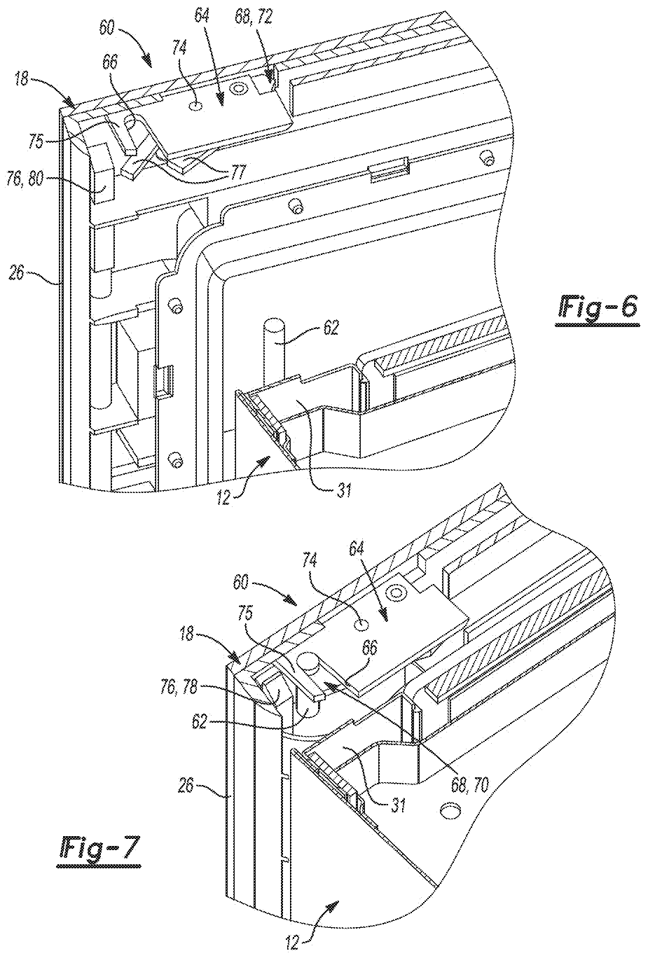

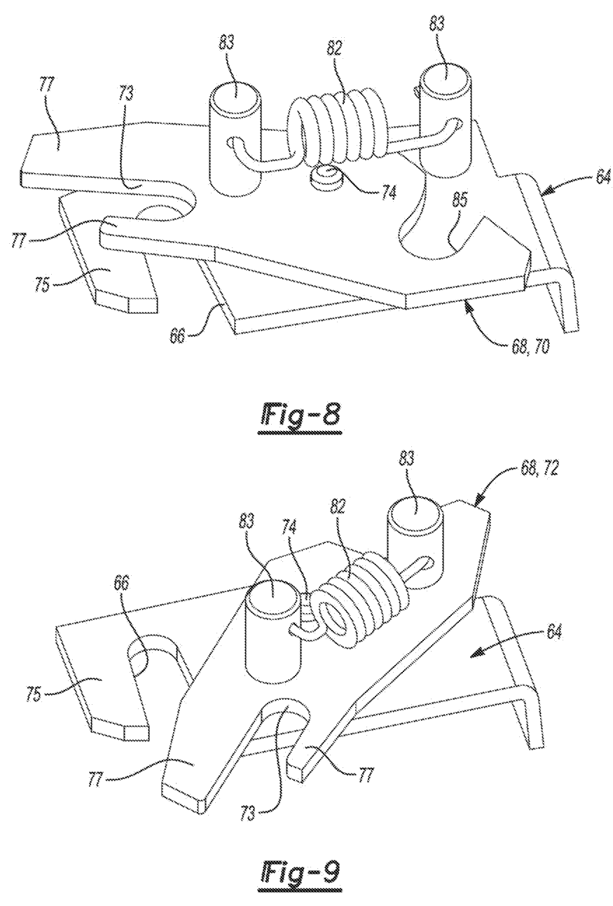

Referring to FIG. 5-9, a second configuration of a door hinge assembly 60 is illustrated. It is noted that the views in FIGS. 5-9 may include cutaway sections or regions where external panels or other elements of the microwave 10 have been removed so that the elements of door hinge assembly 60 are visible. The microwave 10 may include multiple hinge assemblies 60 (e.g., two or more hinge assemblies) that may be attached to and detachable or releasable from opposing sides of the door 18 (e.g., the first side 24 or the second side 26) and/or the opposing side or end regions of the housing 12 (e.g., the first side or end region 29 and the second side or end region 31) so that the door 18 may open to either the first open position 28 or the second open position 30 as illustrated in FIGS. 1 and 2. Furthermore, each of the opposing sides of the door 18 (e.g., the first side 24 and the second side 26 of the door 18) and/or the opposing side or end regions of the housing 12 (e.g., the first side or end region 29 and the second side or end region 31) may include at least two hinge assemblies (e.g., an upper and a lower hinge assembly 60). More specifically, some elements of the hinge assemblies 60 may be attached to the door 18, while other elements of the hinge assemblies 60 may be attached to the housing 12, and the disengagement between the elements of the hinge assemblies 60 that are attached to the door 18 from the elements of the hinge assemblies 60 that are attached to the housing 12 will result in detachment or release of the door 18 from the housing 12 along the correspond side of the door 18 and the correspond side or end region of the housing 12.

It is noted that the hinge assembly 60 illustrated in FIGS. 5-9 is positioned along the second side 26 of the door 18 and the second side or end region 31 of the housing 12. The hinge assembly 60 depicted in FIGS. 5-9, however, may be representative a hinge assembly 60 that is positioned along the first side 24 of the door 18 and the first side or end region 29 of the housing 12. It should be understood, therefore, that a hinge assembly 60 that is positioned along the first side 24 of the door 18 and the first side or end region 29 of the housing 12 may be the mirror image of what is illustrated in FIGS. 5-9.

The hinge assembly 60 is operable to rotatably secure to the door 18 to the housing 12 and to eject or release the door 18 from the housing 12 along one side of the door (e.g., the first side 24 or the second side 26 of the door 18). The hinge assembly 60 includes a pivot, pivot pin, striker pin, or pin 62 that is attached to the housing 12. The hinge assembly 60 further includes a hinge bracket or hinge plate 64 that is secured to the door 18. The hinge plate 64 defines a notch or slot 66 that is operable to receive the pin 62 such that the door 18 is rotatable between an open position (e.g., the first open position 28 or the second open position 30) and a closed position (e.g., closed position 32) via the engagement between the pin 62 and the hinge plate 64 within the slot 66 (e.g., rotation of pin 62 relative to the hinge plate 64 within slot 66). The hinge plate 64 is also operable to release or eject the pin 62 from the slot to 66 facilitate releasing or ejecting the door 18 from the housing 12 along one of the sides of the door 18 (e.g., first side 24 and second side 26 of the door 18).

The hinge assembly 60 may further include a fork bolt or a locking plate 68. The locking plate 68 is operable to transition to a locked position 70 to maintain the pin 62 within the slot 66 and an unlocked position 72 to release or eject the pin 62 from the slot 66. The locked position 70 and the unlocked position 72 may be referred to as first and second positions, or vice versa. The hinge plate 64 and the locking plate 68 may cooperate to maintain the pin 62 within a fixed but rotatable position within the slot 66 when the locking plate 68 is in the locked position 70. For example, the locking plate 68 may define a second notch or slot 73; the hinge plate 64 may include one or more protrusions or arms 75 that extend along opposing sides of and/or define slot 66; the locking plate 68 may include one or more protrusions or arms 77 that extend along opposing sides of and/or define slot 73; and the protrusions or arms (e.g., protrusions or arms 75 and protrusions or arms 77) on both the hinge plate 64 and locking plate 68, along with other regions of the hinge plate 64, completely surround an outer circumference or diameter of pin 62 when the locking plate 68 is in the locked position 70 such the pin 62 is in a fixed but rotatable position within slot 66 and slot 73.

The locking plate 68 may be rotatably secured to the door 18 via a pivot pin 74. The locking plate 68 may be operable to rotate about the pivot pin 74 to the locked position 70 to lock the pin 62 such that the pin 62 facilitates rotation of the door 18 about the pin 62 relative to the housing 12 to transition the microwave door between an open position (e.g., the first open position 28 or the second open position 30) and a closed position (e.g., closed position 32). The locking plate 68 may be operable to rotate about the pivot pin 74 to the unlocked position 72 to unlock the pin 62 such that the door 18 is detachable or releasable from the housing 12 at the pin 62 along one of the sides of the door 18 (e.g., the first side 24 or the second side 26 of the door 18).

The hinge assembly 60 may further include a locking bolt, locking arm, or locking pin 76. The locking pin 76 is operable to engage the locking plate 68 to facilitate maintaining the locking plate 68 in the locked position 70. More specifically, the locking pin 76 is operable to transition to an advanced position 78 to engage one of the arms 77 on the locking plate 68, which prevents the locking plate 68 from transitioning out of the locked position 70 and maintain the pin 62 within slot 66. This ensures that the door 18 remains attached but pivotable about hinge assembly 60 relative to the housing 12 so that the door 18 may transition between an open position (e.g., the first open position 28 or the second open position 30) and a closed position (e.g., closed position 32) along one side of the door (e.g., the first side 24 or the second side 26 of the door 18).

The locking pin 76 is also operable to disengage the locking plate 68 to facilitate transitioning the locking plate 68 to the unlocked position 72. More specifically, the locking pin 76 is operable to transition to a retracted position 80 to disengage one of the arms 77 on the locking plate 68, which allows the locking plate 68 to transitioning from the locked position 70 to the unlocked position 72 and release the pin 62 from the slot 66. This facilitates detachment or release of the door 18 from the housing 12 via the hinge assembly 60 along one side of the door (e.g., the first side 24 or the second side 26 of the door 18).

The locking plate 68 may be operable to engage the pin 62 within the slot 73 when transiting to the locked position 70 to facilitate directing the pin 62 into the slot 66. The locking plate 68 may be further operable to engage the pin 62 within the slot 73 when transitioning to the unlocked position 72 to facilitate directing the pin 62 out of the slot 66.

A first of the hinge assemblies 60 may be disposed along the first side 24 of the door 18. A second of the hinge assemblies 60 may be disposed along the second side 26 of the door 18. The first of the hinge assemblies 60 may facilitate rotating the door 18 relative to the housing 12 along the first side 24 of the door 18 in response to rotatably securing the door 18 to the housing 12 via the first of the hinge assemblies 60 and detaching or releasing the door 18 from the housing 12 via the second of the hinge assemblies 60. The second of the hinge assemblies 60 may facilitate rotating the door 18 relative to the housing 12 along the second side 26 of the door 18 in response to rotatably securing the door 18 to the housing 12 via the second of the hinge assemblies 60 and detaching or releasing the door 18 from the housing 12 via the first of the hinge assemblies 60. Rotatably secured the door 18 to the housing 12 may correspond to the locking plate 68 being in the locked position 70 with the pin 62 disposed within slot 66. Detaching or releasing the door 18 from the housing 12 may correspond to the locking plate 68 transiting to the unlocked position 72 and ejecting the pin 62 from the slot 66.

The hinge assembly 60 includes a biasing element 82 that is operable to bias the locking plate 68 toward the locked position 70 in response to engagement between the locking plate 68 and the pin 62. The biasing element 82 is also operable to bias the locking plate 68 toward the unlocked position 72 in response to disengagement between the locking plate 68 and the pin 62. The biasing element 82 may be a tension spring. The biasing element 82 may be connected to the hinge plate 64 and the locking plate 68. More specifically, the biasing element 82 may be connected to posts 83, where a first of the posts 83 is attached to the hinge plate 64 while a second of the posts 83 is attached to the locking plate 68. The first of the posts 83 may also operate to engage the locking plate 68 within a secondary slot 85 defined by the locking plate 68 to limit rotation of the locking plate 68 when in the unlocked position 72.

The microwave 10 further includes an actuator 84 that is secured to the door 18. The locking pin 76 is operable to retract and disengage the locking plate 68 (e.g., transition to the retracted position 80) in response to engagement of the actuator 84. The locking pin 76 is operable to advance and engage the locking plate 68 (e.g., transition to the advanced position 78) in response to disengagement of the actuator 84. The actuator 84 may comprise a push button. Engagement of the actuator 84 may correspond to depressing the push button. Disengagement of the actuator 84 may correspond to releasing the push button.

The actuator 84 (e.g., push button) may be connected to the locking pin 76, or locking pins 76, via a rack and pinion gearing system 86. The rack and pinion gearing system 86 may include the actuator 84 (e.g., push button), pinion gears 88, racks 90, and other linkages 92 that connect the actuator 84 to the locking pin 76. More specifically, the rack and pinion gearing system 86 may retract and advance upper and lower locking pins 76 to disengage and engage upper and lower locking plates 68, respectively, in response to engagement and disengagement of the actuator 84, respectively. The actuator 84 (e.g., push button) may include rack teeth 94 that engage teeth 96 on the pinion gears 88. The teeth 96 on the pinion gears 88 may in turn engage teeth 98 on the racks 90. The racks 90 are then connected to the locking pins 76 via the linkages 92.

It should be understood that the designations of first, second, third, fourth, etc. for any component, state, or condition described herein may be rearranged in the claims so that they are in chronological order with respect to the claims. Furthermore, it should be understood that any component, state, or condition described herein that does not have a numerical designation may be given a designation of first, second, third, fourth, etc. in the claims if one or more of the specific component, state, or condition are claimed.

The words used in the specification are words of description rather than limitation, and it is understood that various changes may be made without departing from the spirit and scope of the disclosure. As previously described, the features of various embodiments may be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

What is claimed is:

1. A microwave oven comprising:
a housing defining an internal cavity configured to receive foodstuffs for cooking therein;
a door operable to transition between opened and closed positions to provide and restrict access to the internal cavity, respectively; and
a hinge assembly operable to rotatably secure to the door to the housing and to release the door from the housing, the hinge assembly comprising:
a pivot pin attached to the housing,
a hinge plate secured to the door and defining a slot operable to (i) receive the pivot pin such that the door is rotatable between the opened and closed positions via the engagement between the pivot pin and the hinge plate within the slot and (ii) release the pivot pin from the slot to facilitate releasing the door from the housing,
a locking plate operable to transition (i) to a locked position to maintain the pivot pin within the slot and (ii) an unlocked position to eject the pivot pin from the slot, and
a locking pin operable to (i) engage the locking plate to facilitate maintaining the locking plate in the locked position and (ii) disengage the locking plate to facilitate transitioning the locking plate to the unlocked position.

2. The microwave oven of claim 1, wherein the hinge assembly comprises a first hinge assembly, and further comprising a second hinge assembly operable to rotatably secure to the door to the housing and to release the door from the housing.

3. The microwave oven of claim 2, wherein the first and second hinge assemblies are disposed on first and second opposing end regions of the door, respectively, such that (i) rotatably securing the door to the housing via the first hinge assembly and releasing the door from the housing via the second hinge assembly facilities rotating the door relative to the housing along the first end region and (ii) rotatably securing the door to the housing via the second hinge assembly and releasing the door from the housing via the first hinge assembly facilities rotating the door relative to the housing along the second end region.

4. The microwave oven of claim 1, wherein the slot comprises a first slot and the locking plate defines a second slot, wherein the locking plate is operable to (i) engage the pivot pin within the second slot when transiting to the locked position to facilitate directing the pivot pin into first slot and (ii) engage the pivot pin within the second slot when transitioning to the unlocked position to facilitate directing the pivot pin out of first slot.

5. The microwave oven of claim 1 further comprising a biasing element operable to (i) bias the locking plate toward the locked position in response to engagement between the locking plate and the pivot pin and (ii) bias the locking plate toward the unlocked position in response to disengagement between the locking plate and the pivot pin.

6. The microwave oven of claim 1 further comprising an actuator secured to the door, wherein the locking pin is operable to, (i) in response to engagement of the actuator transition the locking pin to disengage the locking plate and (ii) in response to disengagement of the actuator transition the locking pin to engage the locking plate.

7. The microwave oven of claim 6, wherein (i) the actuator comprises a push button, (ii) engagement of the actuator corresponds to depressing the push button, and (iii) disengagement of the actuator corresponds to releasing the push button.

8. The microwave oven of claim 7, wherein the push button is connected to the locking pin via a rack and pinion gearing system.

9. A hinge assembly comprising:
a striker pin secured to one of a microwave door and a microwave housing;
a fork bolt pivotably (i) secured to the other of the microwave door and the microwave housing, (ii) operable to rotate to a first position to lock the striker pin such that the striker pin facilitates rotation of the microwave door about the striker pin relative to the microwave housing to transition the microwave door between opened and closed positions, and (iii) operable to rotate to a second position to unlock the striker pin such that the microwave door is detachable from the microwave housing at the striker pin; and
a lock pin operable to (i) advance to engage the fork bolt to maintain the fork bolt in the first position and (ii) retract to disengage the fork bolt to facilitate transitioning the fork bolt to the second position.

10. The hinge assembly of claim 9 further comprising a hinge plate secured to the other of the microwave door and the microwave housing and defining a slot operable to (i) receive the striker pin such that the microwave door is rotatable between the opened and closed positions via the engagement between the striker pin and the hinge plate within the slot and (ii) release the striker pin from the slot to facilitate detaching the microwave door from the microwave housing.

11. The hinge assembly of claim 10, wherein the slot comprises a first slot and the fork bolt defines a second slot, wherein the fork bolt is operable to (i) engage the striker pin within the second slot when transiting to the first position to facilitate directing the striker pin into first slot and (ii) engage the striker pin within the second slot when transitioning to the second position to facilitate directing the striker pin out of first slot.

12. The hinge assembly of claim 9 further comprising a biasing element operable to (i) bias the fork bolt toward the first position in response to engagement between the fork bolt and the striker pin and (ii) bias the fork bolt toward the second position in response to disengagement between the fork bolt and the striker pin.

13. The hinge assembly of claim 9 further comprising an actuator, wherein the locking pin is operable to, (i) in response to engagement of the actuator retract the locking pin and (ii) in response to disengagement of the actuator advance the locking pin.

14. The hinge assembly of claim 13, wherein (i) the actuator comprises a push button, (ii) engagement of the actuator corresponds to depressing the push button, and (iii) disengagement of the actuator corresponds to releasing the push button.

15. The hinge assembly of claim 14, wherein the push button is connected to the locking pin via a rack and pinion gearing system.

16. A microwave oven comprising:
a cabinet;
a door operable to transition between opened and closed positions; and
a hinge assembly comprising:
a pin secured to one of the cabinet and the door,
a hinge bracket secured to the other of the cabinet and the door, and
a resilient clip (i) secured to the hinge bracket, (ii) operable to receive the pin in response to a first force from the pin acting on the resilient clip in a first direction, (iii) operable to facilitate rotational movement between the pin and the hinge bracket to transition the door between the opened and closed positions, and (iv) operable to release the pin to detach the door from the cabinet at the pin in response to a second force from the pin acting on the resilient clip in a second direction.

17. The microwave oven of claim 16, wherein the hinge assembly comprises a first hinge assembly, and further comprising a second hinge assembly, wherein (i) the first and second hinge assemblies are disposed on first and second opposing end regions of the door, respectively, (ii) the first hinge assembly facilitates rotating the door relative to the cabinet along the first end region in response to the resilient clip receiving the pin, and (iii) the second hinge assembly facilitates rotating the door relative to the cabinet along the second end region in response to the resilient clip releasing the pin.

18. The microwave oven of claim 16, wherein the resilient clip defines an open end operable for guiding the pin into and out of the clip.

19. The microwave oven of claim 18, wherein the resilient clip includes first and second resilient arms disposed on opposing sides of the open end.

20. The microwave oven of claim 16, wherein the resilient clip is operable to receive and release the pin in response to the first and second forces exceeding first and second thresholds, respectively.
